(19) United States
(12) Patent Application Publication
(10) Pub. No.: US 2015/0114782 A1
(43) Pub. Date: Apr. 30, 2015

(54) TORQUE HINGE OR TORQUE LIMITER

(71) Applicant: TOKYO BYOKANE CO., LTD., Tokyo (JP)

(72) Inventor: Kesatomo SAITO, Tokyo (JP)

(21) Appl. No.: 14/518,136

(22) Filed: Oct. 20, 2014

(30) Foreign Application Priority Data
Oct. 24, 2013 (JP) 2013-220844

(51) Int. Cl. E05D 11/08; F16D 13/12; F16C 11/04

(52) U.S. Cl. CPC E05D 11/084; F16C 11/04; F16D 13/12; F16C 2361/43
USPC 192/31; 16/337; 464/40

(57) ABSTRACT

A torque hinge or torque limiter includes external and internal cylindrical members that are capable of relatively rotating, and a coil spring placed between the external and internal cylindrical members. A first circumferential portion is formed on a front-end side of the inner periphery of the external cylindrical member. A second circumferential portion is formed on a rear-end side of the outer periphery of the internal cylindrical member. The torque value that blocks the rotary torque of the external or internal cylindrical member in a first arbitrary direction is set by pressing the first circumferential portion against the outer circumferential portion of the coil spring. The torque value that blocks the rotary torque of the external or internal cylindrical member in a second arbitrary direction is set by pressing the second circumferential portion against the inner circumferential portion of the coil spring.

### BACKGROUND

1. Technical Field

The present invention relates to a torque hinge used for an opening and closing mechanism requiring setting different torque values for opening and closing, for example, the cover portion of a laptop computer, or to a torque limiter used for a mechanism requiring setting different torque values for a positive rotation and negative rotation, for example, of the paper feeding device in a printing mechanism, and especially relates to a torque hinge or torque limiter in which a coil spring is placed between the external cylindrical member and the internal cylindrical member.

2. Related Art

A torque hinge or torque limiter in which a coil spring is placed between the external cylindrical member and the internal cylindrical member, and in which a torque value that blocks the transmission of rotary torque from one to the other of the external cylindrical member and the internal cylindrical member using an increasing or decreasing action on the diameter of the coil spring when the rotation of the external cylindrical member or internal cylindrical member adds, to the coil spring, a force in the same direction as or the opposite direction to the turn of the coil, in other words, a torque value that idles the external cylindrical member or the internal cylindrical member is set is known as an existing torque value or torque.

JP 7-229524 A especially discloses a bidirectional torque limiter in which the torque value relative to the rotation of the external cylindrical member or internal cylindrical member in a first arbitrary direction, and the torque value relative to the rotation of the external cylindrical member or internal cylindrical member in a second arbitrary direction can separately be set.

The torque limiter in JP 7-229524 A is configured to use a coil spring including a right-handed coil portion and a left-handed coil portion connected to each other through a bend portion so as to set the torque value during the rotation in the first arbitrary direction by housing a first coil portion in a cylindrical housing portion integrally formed on the outer circumference of an internal cylindrical member and pressing the outer circumferential portion of the first coil portion against the inner periphery of the cylindrical housing portion and so as to set the torque value during the rotation in the second arbitrary direction by pressing the outer circumferential portion of a second coil portion against the inner periphery of an external cylindrical member.

Accordingly, when the rotation of the external cylindrical member or internal cylindrical member reduces the diameter of the first coil portion, the contact pressure between the first coil portion and the inner periphery of the cylindrical housing portion formed on the internal cylindrical member decreases. This blocks the torque transmission. Alternatively, when the negative rotation reduces the diameter of the second coil portion, the contact pressure between the second coil portion and the inner periphery of the external cylindrical member decreases. This blocks the torque transmission.

### PRIOR ART DOCUMENT

### Patent Document

Patent Document 1: JP 7-229524 A

### SUMMARY

The torque limiter in JP 7-229524 A requires using a dedicated coil spring that includes two coil portions of which turns are in different directions and a bend portion connecting both of the coil portions to each other as described above. This increases the cost and causes a problem that the bend portion is easily broken because a twisting force is added to the bend portion.

The torque limiter in JP 7-229524 A requires forming the cylindrical housing portion on the internal cylindrical member. This also causes a problem that the structure is complicated.

Even when the torque limiter in JP 7-229524 A is used as a torque hinge, there are the same problems.

The present invention efficiently solves the problems in the existing torque hinge or torque limiter described above and provides a torque hinge or torque limiter having a simple structure that appropriately uses the decrease and increase in the diameter of a coil spring.

Briefly, a torque hinge or torque limiter according to the present invention includes: an external cylindrical member and an internal cylindrical member that are placed so as to be capable of relatively rotating; a coil spring placed between an inner periphery of the external cylindrical member and an outer periphery of the internal cylindrical member; and a structure in which a first circumferential portion extending in a direction in which an inner diameter of the external cylindrical member decreases is formed on a front-end side of the inner periphery of the external cylindrical member, a second circumferential portion extending in a direction in which an outer diameter of the internal cylindrical member increases is formed on a rear-end side of the outer periphery of the internal cylindrical member, the coil spring is forcibly inserted into the first circumferential portion of the external cylindrical member, and the second circumferential portion of the internal cylindrical member is forcibly inserted into the inner circumferential portion of the coil spring.

To facilitate the assembly, it is preferable that a first tapered surface portion that leads to the forcible insertion of the coil spring into the first circumferential portion is formed in the inner periphery of the external cylindrical member, and a second tapered surface portion that leads to the forcible insertion of the second circumferential portion into the coil spring is formed on the outer periphery of the internal cylindrical member.

The coil spring is formed such that the diameter gradually decreases from the front end in which the coil spring is forcibly inserted into the first circumferential portion to the rear end in which the forcible insertion of the second circumferential portion is received. This causes the first circumferential portion to surely be pressed against the outer circumferential portion of the coil spring, and causes the second circumferential portion to surely be pressed against the inner circumferential portion of the coil spring.

The torque hinge or torque limiter according to the present invention can appropriately control the bidirectional torque transmission by efficiently using the decrease and increase in the diameter of the coil spring formed of a coil wound from a first end to a second end in the same direction with a simple structure in which the first circumferential portion is formed on the external cylindrical member and the second circumferential portion is formed on the internal cylindrical member.

The simple structure can appropriately respond to the requirement of miniaturization.

Changing the inner diameter or width dimension of the first circumferential portion can readily change the torque value to be set. Similarly, changing the outer diameter or width dimension of the second circumferential portion can readily change the torque value to be set.

### BRIEF DESCRIPTION OF DRAWINGS

FIG. 1 is an exploded cross-sectional diagram of a torque hinge or torque limiter according to a first embodiment of the present invention;

FIG. 2 is a cross-sectional diagram of the assembled torque hinge or torque limiter according to the first embodiment;

FIG. 3 is an exploded cross-sectional diagram of a torque hinge or torque limiter according to a second embodiment of the present invention;

FIG. 4 is a cross-sectional diagram of the assembled torque hinge or torque limiter according to the second embodiment;

FIG. 5A is an explanatory diagram of the outline of the block of the torque when an internal cylindrical member rotates in a first arbitrary direction; and

FIG. 5B is an explanatory diagram of the outline of the block of the torque when the internal cylindrical member rotates in a second arbitrary direction.

### DETAILED DESCRIPTION

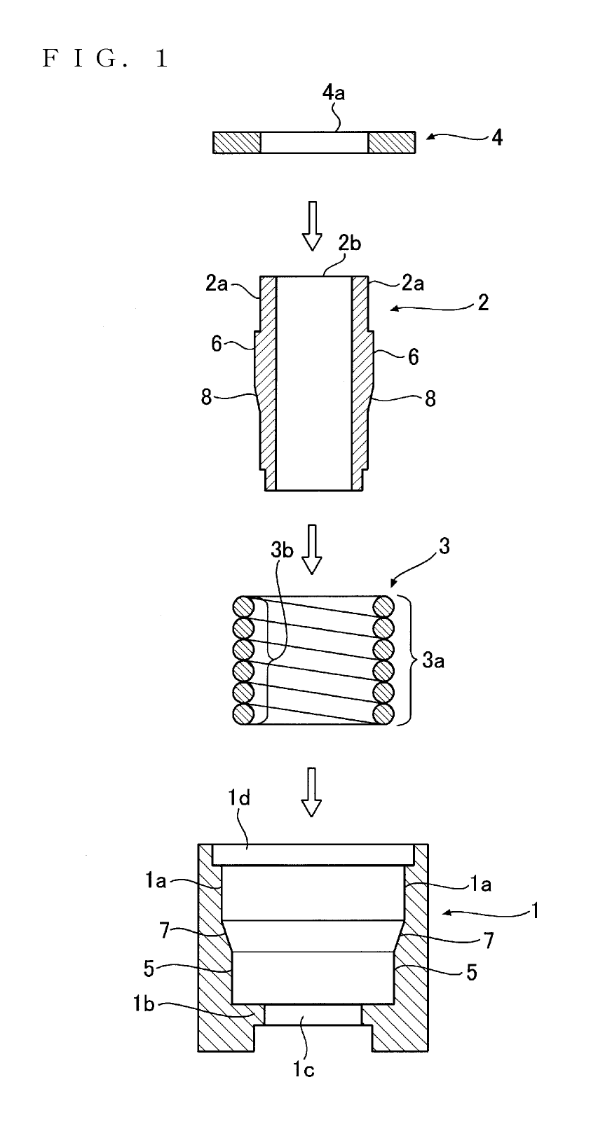

The embodiments of the torque hinge or torque limiter according to the present invention will be described hereinafter based on FIG. 1 to FIG. 5B.

### First Embodiment

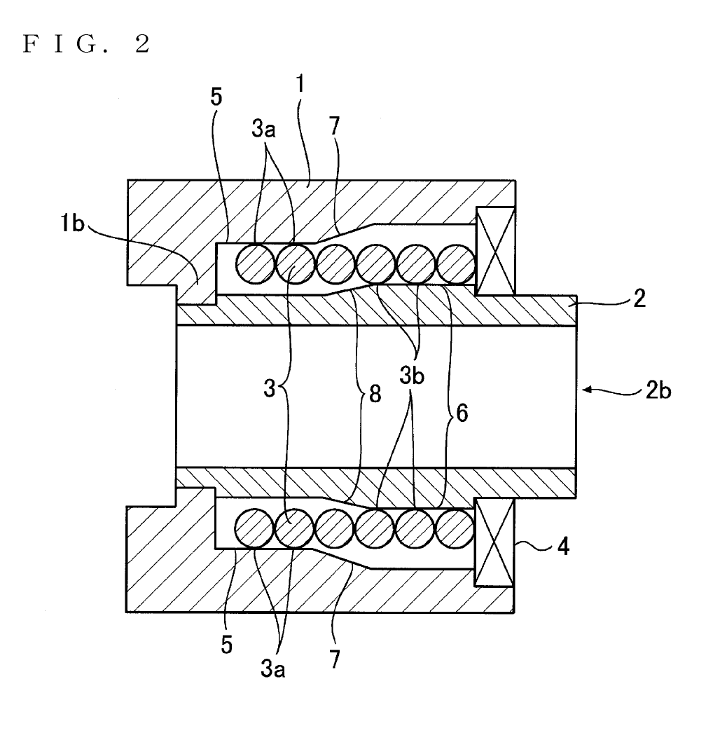

As illustrated in FIG. 1 and FIG. 2, the torque hinge or torque limiter according to the first embodiment includes an external cylindrical member 1 and internal cylindrical member 2 placed so as to be capable of relatively rotating, and a coil spring 3 placed between an inner periphery 1a of the external cylindrical member 1 and an outer periphery 2a of the internal cylindrical member 2 as a basic structure.

Next, the structure of each of the members will be described. First, the external cylindrical member 1 has a structure in which an end plate 1b is included in a front end (a first end) of the external cylindrical member 1, an insertion hole 1c into which a front end (a first end) of the internal cylindrical member 2 is inserted is formed at the center of the end plate 1b, and a fitting hole 1d into which a cover member 4 is fitted is formed on a rear end (a second end) of the external cylindrical member 1.

The external cylindrical member 1 further has a structure in which a first circumferential portion 5 extending in a direction in which the inner diameter of the external cylindrical member 1 is reduced is formed on the inner periphery 1a of the external cylindrical member 1, and a first tapered surface portion 7 is continuously formed on the rear end of the first circumferential portion 5. In other words, the first circumferential portion 5 is a periphery having a smaller diameter than that of the inner periphery 1a, and the first tapered surface portion 7 is formed between the rear end of the first circumferential portion 5 and the inner periphery 1a. As to be described below, the first tapered surface portion 7 leads to the forcible insertion of the front-end portion of the coil spring 3 into the first circumferential portion 5. The forcible insertion presses the first circumferential portion 5 against an outer circumferential portion 3a on the front-end side of the coil spring 3.

The internal cylindrical member 2 is a pipe-shaped member including a through hole 2b, and has a structure in which a second circumferential portion 6 extending in a direction in which the outer diameter of the internal cylindrical member 2 is increased is formed on the outer periphery 2a, and a second tapered surface portion 8 is continuously formed on the front end of the second circumferential portion 6. In other words, the second circumferential portion 6 is a periphery having a larger diameter than the outer periphery 2a, and the second tapered surface portion 8 is formed between the front end of the second circumferential portion 6 and the outer periphery 2a. As to be described below, the second tapered surface portion 8 leads to the forcible insertion of the second circumferential portion 6 into the coil spring 3. The forcible insertion presses the second circumferential portion 6 against the inner circumferential portion 3b on the rear-end side of the coil spring 3.

The coil spring 3 is formed of a coil wound from a front end (a first end) to a rear end (a second end) in the same direction and the same diameter. The cover member 4 is a plate-shaped member centrally including a receiving hole 4a configured to receive the rear-end portion of the internal cylindrical member 2.

The torque hinge or torque limiter according to the present embodiment has a structure including each of the members described above, and is assembled as illustrated in FIG. 2. The front-end portion (the first end portion) of the coil spring 3 is forcibly inserted into the first circumferential portion 5 of the external cylindrical member 1 using the first tapered surface portion 7 while the second circumferential portion 6 of the internal cylindrical member 2 is forcibly inserted into the inner circumferential portion 3b of the rear-end portion (the second end portion) of the coil spring 3 using the second tapered surface portion 8. Finally, the cover member 4 is fitted into the fitting hole 1d of the external cylindrical member 1.

Accordingly, when the external cylindrical member 1 or the internal cylindrical member 2 is at no load, the first circumferential portion 5 formed in the external cylindrical member 1 is pressed against the outer circumferential portion 3a of the coil spring 3 facing the first circumferential portion 5, and the second circumferential portion 6 formed in the internal cylindrical member 2 is pressed against the inner circumferential portion 3b of the coil spring 3 facing the second circumferential portion 6.

The torque value blocking the transmission of the rotary torque from one to the other of the external cylindrical member 1 and the internal cylindrical member 2, namely, the maximum transmittable torque value can be set using the contact pressure between the first circumferential portion 5 of the external cylindrical member 1 and the outer circumferential portion 3a of the coil spring 3, or the contact pressure between the second circumferential portion 6 of the internal cylindrical member 2 and the inner circumferential portion 3b of the coil spring 3.

In other words, the torque value blocking the rotary torque of the external cylindrical member 1 or internal cylindrical member 2 in a first arbitrary direction (hereinafter, referred to as a first torque value) is set using the contact pressure between the first circumferential portion 5 of the external cylindrical member 1 and the outer circumferential portion 3a of the coil spring 3. The torque value blocking the rotary torque of the external cylindrical member 1 or internal cylindrical member 2 in a second arbitrary direction (hereinafter, referred to as a second torque value) is set using the contact pressure by forcible insertion between the second circumferential portion 6 of the internal cylindrical member 2 and the inner circumferential portion 3b of the coil spring 3.

Thus, adjusting the inner diameter or width dimension of the first circumferential portion 5 can change the first torque value, and adjusting the outer diameter or width dimension of the second circumferential portion 6 can change the second torque value.

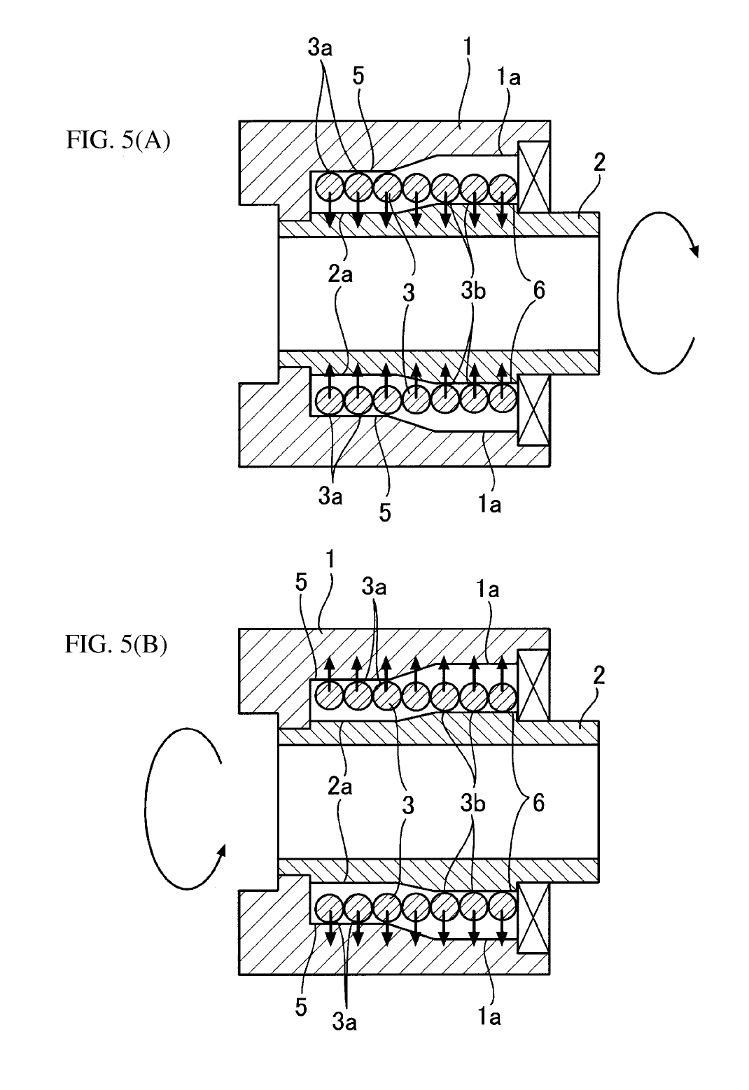

The block of the rotary torque will be described herein based on FIGS. 5A and 5B. Note that FIGS. 5A and 5B illustrate that the internal cylindrical member 2 is under load and the internal cylindrical member 2 rotates.

As illustrated in FIG. 5A, rotating the internal cylindrical member 2 in the same direction as the direction of the turn of the coil of the coil spring 3 (the direction of the clockwise arrow in the drawing) reduces the diameter of the spring 3 and increases the contact pressure between the inner circumferential portion 3b on the rear-end side of the coil spring 3 and the second circumferential portion 6 of the internal cylindrical member 2. This causes the coil spring 3 to rotate together with the internal cylindrical member 2. In addition, the outer circumferential portion 3a on the front-end side of the coil spring 3 is still pressed against the first circumferential portion 5 of the external cylindrical member 1. Thus, the rotary torque of the internal cylindrical member 2 is transmitted to the external cylindrical member 1.

When the rotary torque of the internal cylindrical member 2 exceeds the torque value set as the first torque value, the contact pressure between the first circumferential portion 5 and the outer circumferential portion 3a of the coil spring 3 decreases. This causes the outer circumferential portion 3a of the coil spring 3 to slide on the first circumferential portion 5. This blocks the transmission of the rotary torque from the internal cylindrical member 2 to the external cylindrical member 1. The internal cylindrical member 2 idles together with the coil spring 3 in the external cylindrical member 1.

As illustrated in FIG. 5B, rotating the internal cylindrical member 2 in the opposite direction to the direction of the turn of the coil of the coil spring 3 (the direction of the counterclockwise arrow in the drawing) increases the diameter of the spring 3 and increases the contact pressure between the outer circumferential portion 3a on the front-end side of the coil spring 3 and the first circumferential portion 5 of the external cylindrical member 1. The rotary torque of the internal cylindrical member 2 is transmitted to the external cylindrical member 1 through the coil spring 3. At that time, the inner circumferential portion 3b on the rear-end side of the coil spring 3 is still pressed against the second circumferential portion 6 of the internal cylindrical member 2. The coil spring 3 rotates together with the internal cylindrical member 2 so as to transmit the rotary torque to the external cylindrical member 1.

When the rotary torque of the internal cylindrical member 2 exceeds the torque value set as the second torque value, the contact pressure between the second circumferential portion 6 and the inner circumferential portion 3b of the coil spring 3 decreases. This causes the second circumferential portion 6 to slide on the inner circumferential portion 3b of the coil spring 3. This blocks the transmission of the rotary torque from the internal cylindrical member 2 to the external cylindrical member 1. The internal cylindrical member 2 idles in the external cylindrical member 1 (in the inner circumferential portion 3b of the coil spring 3).

As described above, the torque hinge or torque limiter according to the present embodiment can appropriately transmit and block the torque in the bidirectional rotations of the internal cylindrical member 2 with the simple structure. The description above is incorporated as the description of the transmission and block of the torque when the external cylindrical member 1 rotates and when both of the external cylindrical member 1 and the internal cylindrical member 2 rotate because the transmission and block are the same as when the internal cylindrical member 1 rotates as described above.

### Second Embodiment

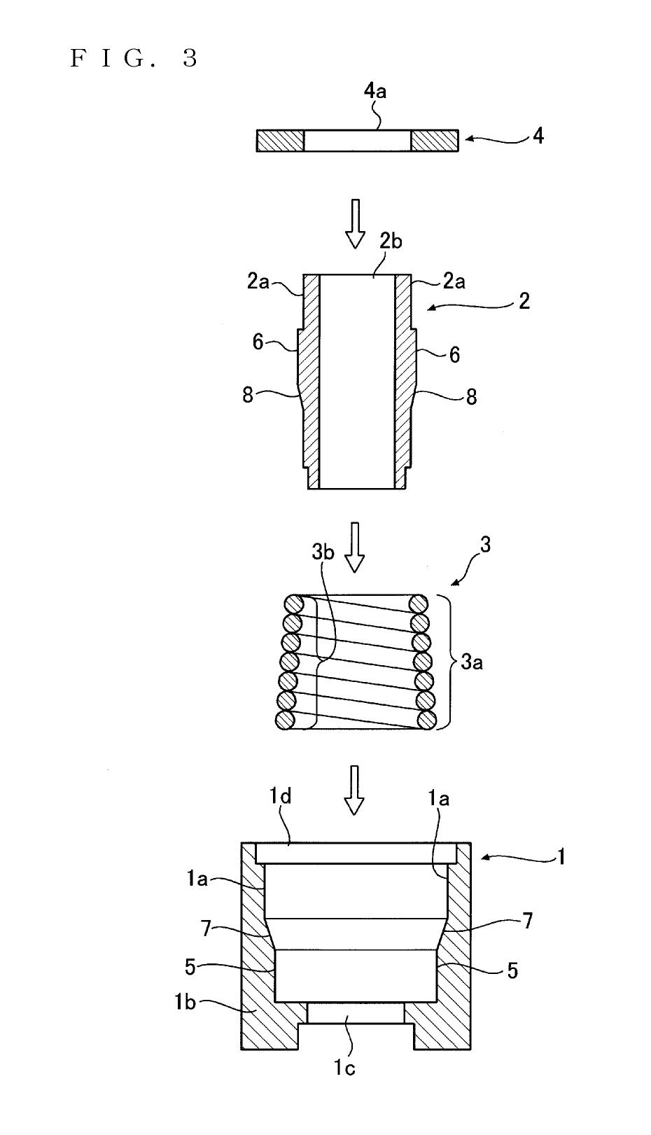

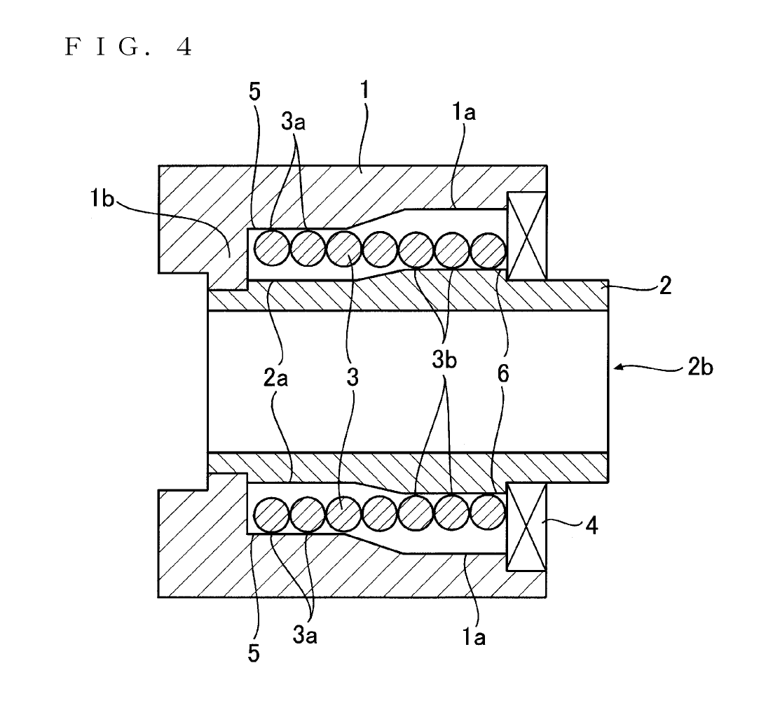

As illustrated in FIG. 3 and FIG. 4, the torque hinge or torque limiter according to the second embodiment has the same basic structure, structure of an external cylindrical member 1, structure of an internal cylindrical member 2, and structure of a cover member 4 as in the first embodiment described above. Thus, the descriptions will be omitted herein.

The characteristic of the present embodiment is the point that the coil is wound such that the diameter of the coil spring 3 gradually decreases from the front end (the first end) to the rear end (the second end).

In other words, in the present embodiment, the first circumferential portion 5 of the external cylindrical member 1 can more surely be pressed against the outer circumferential portion 3a on the front-end side of the coil spring 3. Similarly, the second circumferential portion 6 of the internal cylindrical member 2 can more surely be pressed against the inner circumferential portion 3b on the rear-end side of the coil spring 3.

Note that the settings of the first and second torque values and the transmission and block of the rotary torque from one to the other of the external cylindrical member 1 and the internal cylindrical member 2 in the present embodiment are the same as in the first embodiment described above. Thus, the contents described in the first embodiment are incorporated herein.

In the present embodiment, adjusting the degree of the decrease in the diameter of the coil spring 3 from the front end to the rear end can readily change the first and second torque values.

As described above, the torque hinge or torque limiter according to the present invention has a simple structure in which the first circumferential portion 5 having a smaller diameter than that of the inner periphery 1a of the external cylindrical member 1 is formed in the external cylindrical member 1 and the second circumferential portion 6 having a larger diameter than that of the outer periphery 2a of the internal cylindrical member 2 is formed in the internal cylindrical member 2. This can bi-directionally transmit the torque or block the torque transmission appropriately using the decrease or increase in the diameter of the coil spring 3 efficiently.

With the miniaturization of an electric appliance, office automation equipment, or the like, the simple structure can appropriately respond to the requirement of miniaturization of the torque hinge or torque limiter used for the appliance, equipment, or the like if necessary.

Changing the inner diameter or width dimension of the first circumferential portion 5 can readily change the first torque value. Similarly, changing the outer diameter or width dimension of the second circumferential portion 6 can readily change the second torque value. Furthermore, as described in the second embodiment, the coil spring 3 is formed such that the diameter of the turn drastically decreases from the front-end side to the rear-end side. This can surely set the first and second torque values and change the torque values.

1. A torque hinge comprising:
an external cylindrical member and an internal cylindrical member that are placed so as to be capable of relatively rotating; and
a coil spring placed between an inner periphery of the external cylindrical member and an outer periphery of the internal cylindrical member,
wherein a first circumferential portion extending in a direction in which an inner diameter of the external cylindrical member decreases is formed on a front-end side of the inner periphery of the external cylindrical member,
a second circumferential portion extending in a direction in which an outer diameter of the internal cylindrical member increases is formed on a rear-end side of the outer periphery of the internal cylindrical member,
the coil spring is forcibly inserted into the first circumferential portion of the external cylindrical member, and
the second circumferential portion of the internal cylindrical member is forcibly inserted into the inner circumferential portion of the coil spring.

2. The torque hinge according to claim 1, wherein a first tapered surface portion that leads to the forcible insertion of the coil spring into the first circumferential portion is formed in the inner periphery of the external cylindrical member, and
a second tapered surface portion that leads to the forcible insertion of the second circumferential portion into the coil spring is formed on the outer periphery of the internal cylindrical member.

3. The torque hinge according to claim 1, wherein the coil spring is formed such that a diameter of the coil spring gradually decreases from a front end in which the coil spring is forcibly inserted into the first circumferential portion to a rear end in which the forcible insertion of the second circumferential portion is received.

4. A torque limiter comprising:
an external cylindrical member and an internal cylindrical member that are placed so as to be capable of relatively rotating; and
a coil spring placed between an inner periphery of the external cylindrical member and an outer periphery of the internal cylindrical member,
wherein a first circumferential portion extending in a direction in which an inner diameter of the external cylindrical member decreases is formed on a front-end side of the inner periphery of the external cylindrical member,
a second circumferential portion extending in a direction in which an outer diameter of the internal cylindrical member increases is formed on a rear-end side of the outer periphery of the internal cylindrical member,
the coil spring is forcibly inserted into the first circumferential portion of the external cylindrical member, and
the second circumferential portion of the internal cylindrical member is forcibly inserted into the inner circumferential portion of the coil spring.

5. The torque limiter according to claim 4, wherein a first tapered surface portion that leads to the forcible insertion of the coil spring into the first circumferential portion is formed in the inner periphery of the external cylindrical member, and
a second tapered surface portion that leads to the forcible insertion of the second circumferential portion into the coil spring is formed on the outer periphery of the internal cylindrical member.

6. The torque limiter according to claim 4, wherein the coil spring is formed such that a diameter of the coil spring gradually decreases from a front end in which the coil spring is forcibly inserted into the first circumferential portion to a rear end in which the forcible insertion of the second circumferential portion is received.

7. The torque hinge according to claim 2, wherein the coil spring is formed such that a diameter of the coil spring gradually decreases from a front end in which the coil spring is forcibly inserted into the first circumferential portion to a rear end in which the forcible insertion of the second circumferential portion is received.

8. The torque limiter according to claim 5, wherein the coil spring is formed such that a diameter of the coil spring gradually decreases from a front end in which the coil spring is forcibly inserted into the first circumferential portion to a rear end in which the forcible insertion of the second circumferential portion is received.
